(19) United States
(12) Patent Application Publication
(10) Pub. No.: US 2025/0157205 A1
(43) Pub. Date: May 15, 2025

(54) METHOD AND APPARATUS WITH IMAGE ENHANCEMENT USING BASE IMAGE

(71) Applicants: Samsung Electronics Co., Ltd., Suwon-si (KR); POSTECH RESEARCH AND BUSINESS DEVELOPMENT FOUNDATION, Pohang-si (KR)

(72) Inventors: Jae seok CHOI, Suwon-si (KR); Manjin KIM, Pohang-si (KR); SangHyun KIM, Pohang-si (KR); Woohyeok KIM, Pohang-si (KR); Insoo KIM, Suwon-si (KR); Min Jung LEE, Pohang-si (KR); Jaesung RIM, Pohang-si (KR); Deun Sol JUNG, Pohang-si (KR); Minsu CHO, Pohang-si (KR); Sunghyun CHO, Pohang-si (KR)

(73) Assignees: Samsung Electronics Co., Ltd., Suwon-si (KR); POSTECH RESEARCH AND BUSINESS DEVELOPMENT FOUNDATION, Pohang-si (KR)

(21) Appl. No.: 18/934,024

(22) Filed: Oct. 31, 2024

(30) Foreign Application Priority Data
Nov. 9, 2023 (KR) 10-2023-0154857
Dec. 15, 2023 (KR) 10-2023-0183342

(51) Int. Cl. G06V 10/80; G06T 7/20; G06V 10/44; G06V 10/62; G06V 10/74; G06V 10/771

(52) U.S. Cl. CPC G06V 10/806; G06T 7/20; G06V 10/44; G06V 10/62; G06V 10/761; G06V 10/771

(57) ABSTRACT

A method and apparatus with image enhancement using a base image are provided. The method includes: extracting, by a spatial feature extractor, intra-image spatial feature representations from respective image frames of a burst image set; generating inter-image temporal feature representations based on a local similarity between the spatial feature representations; determining temporal-spatial feature representations of the respective image frames by fusing the spatial feature representations with the temporal feature representations; selecting a base image frame from among the image frames based on the temporal-spatial feature representations; and generating an enhanced image by performing an image enhancement operation on the burst image set based on the base image frame.

### CROSS-REFERENCE TO RELATED APPLICATIONS

This application claims the benefit under 35 USC § 119(a) of Korean Patent Application No. 10-2023-0154857, filed on Nov. 9, 2023, and 10-2023-0183342, filed on Dec. 15, 2023, in the Korean Intellectual Property Office, the entire disclosure of which are incorporated herein by reference for all purposes.

### BACKGROUND

### 1. Field

The following description relates to a method and apparatus with image enhancement using a base image.

### 2. Description of Related Art

Image enhancement technology involves enhancing an image of degraded quality to an image of improved quality. A deep learning-based neural network may perform various types of image enhancements. Such a neural network may be trained based on deep learning and may perform inference for a desired purpose by mapping input data and output data that are in a nonlinear relationship to each other, e.g., an input image to an enhanced output image. A trained ability to generate such mapping may be referred to as a learning ability of the neural network. Furthermore, a neural network trained for a special purpose such as image restoration may have a generalization ability to generate a relatively accurate output in response to, for example, an input pattern with which the neural network has not yet been trained.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an image enhancement method includes: extracting, by a spatial feature extractor, intra-image spatial feature representations from respective image frames of a burst image set; generating inter-image temporal feature representations based on a local similarity between the spatial feature representations; determining temporal-spatial feature representations of the respective image frames by fusing the spatial feature representations with the temporal feature representations; selecting a base image frame from among the image frames based on the temporal-spatial feature representations; and generating an enhanced image by performing an image enhancement operation on the burst image set based on the base image frame.

The generating of the temporal feature representations may include: selecting a target spatial feature representation from among the spatial feature representations; comparing window regions of the target spatial feature representation with spatially-corresponding search regions of the spatial feature representations; and generating a temporal feature representation corresponding to the target spatial feature representation based on a result of the comparison, the temporal feature representation being included in the temporal feature representations.

The comparing of the window regions of the target spatial feature representation with the spatially-corresponding search regions of the spatial feature representations may include: selecting a first spatial feature representation from among the spatial feature representations; comparing a first window region of the window regions of the target spatial feature representation with a first search region spatially-corresponding to the first window region in the first spatial feature representation; and comparing a second window region of the window regions of the target spatial feature representation with a second search region spatially-corresponding to the second window region in the first spatial feature representation.

The temporal feature representations include: motion information of the respective image frames.

The determining of the temporal-spatial feature representations may include: causing a size of the spatial feature representations to equal a size of the temporal feature representations; and determining the temporal-spatial feature representations based on an elementwise addition operation of feature values of the spatial feature representations and feature values of the temporal feature representations.

The generating of the temporal feature representations and the determining of the temporal-spatial feature representations may be iteratively performed, and the base image frame may be selected based on final temporal-spatial feature representations obtained as a result of the iterations.

The individual image frames may have composite degradation.

The individual image frames may be captured with different respective exposure times.

The selecting of the base image frame may include: generating a selection guide vector corresponding to the temporal-spatial feature representations, wherein elements of the selection guide vector respectively correspond to the frame images; and selecting the base image frame from among the individual image frames based on values of the elements of the selection guide vector.

The temporal feature representations may be feature maps generated by a first neural network, the spatial-temporal features may be feature maps generated by second neural network, and a spatial-temporal feature map may include spatial-temporal features of a corresponding image frame relative to other of the image frames.

In another general aspect, an electronic device includes: one or more processors; and a memory storing instructions configured to cause the one or more processors to: extract, by a spatial feature extractor, intra-image spatial feature representations from respective image frames of a burst image set; generate inter-image temporal feature representations based on a local similarity between the spatial feature representations; determine temporal-spatial feature representations of the respective image frames by fusing the spatial feature representations with the temporal feature representations; select a base image frame from among the individual image frames based on the temporal-spatial feature representations; and generate an enhanced image by performing an image enhancement operation on the burst image set based on the base image frame.

12. The electronic device of claim 11, wherein, in order to generate the temporal feature representations, the instructions may be further configured to cause the one or more processors to: select a target spatial feature representation from among the spatial feature representations; compare window regions of the target spatial feature representation with spatially-corresponding search regions of the spatial feature representations; and generate a temporal feature representation corresponding to the target spatial feature representation based on a result of the comparison, the temporal feature representation being included in the temporal feature representations.

In order to compare the window regions of the target spatial feature representation with the search regions of the spatial feature representations, the instructions may be further configured to cause the one or more processors to: select a first spatial feature representation from among the spatial feature representations; compare a first window region of the window regions of the target spatial feature representation with a first search region spatially-corresponding to the first window region in the first spatial feature representation; and compare a second window region of the window regions of the target spatial feature representation with a second search region spatially-corresponding to the second window region in the first spatial feature representation.

The temporal feature representations may include: motion information of the respective image frames.

In order to determine the temporal-spatial feature representations, the instructions may be further configured to cause the one or more processors to: cause a size of the spatial feature representations to equal a size of the temporal feature representations; and determine the temporal-spatial feature representations based on an elementwise addition operation of feature values of the spatial feature representations and feature values of the temporal feature representations.

The generating of the temporal feature representations and the determining of the temporal-spatial feature representations may be iteratively performed, and the base image frame may be selected based on final temporal-spatial feature representations obtained as a result of the iterations.

The individual image frames may have composite degradation.

The electronic device may further include: a camera configured to capture the burst image set.

The camera may be configured to: capture the individual image frames of the burst image set with different respective exposure times.

In order to select the base image frame, the instructions may be further configured to cause the one or more processors to: generate a selection guide vector corresponding to the temporal-spatial feature representations, wherein elements of the selection guide vector may respectively correspond to the frame images; and select the base image frame from among the individual image frames based on values of the elements of the selection guide vector.

Other features and aspects will be apparent from the following detailed description, the drawings, and the claims.

### BRIEF DESCRIPTION OF THE DRAWINGS

FIG. 1 illustrates an example of generating an enhanced image from a burst image set, according to one or more embodiments.

FIG. 2 illustrates an example of a base image selector, according to one or more embodiments.

FIG. 3 illustrates an example of a temporal-spatial feature generator, according to one or more embodiments.

FIG. 4 illustrates an example of an iterative operation of a temporal-spatial feature generator, according to one or more embodiments.

FIG. 5 illustrates an example configuration of a temporal feature generator, according to one or more embodiments.

FIG. 6 illustrates an example similarity calculation using window regions and search regions, according to one or more embodiments.

FIG. 7 illustrates an example image enhancement method, according to one or more embodiments.

FIG. 8 illustrates an example of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, orA, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

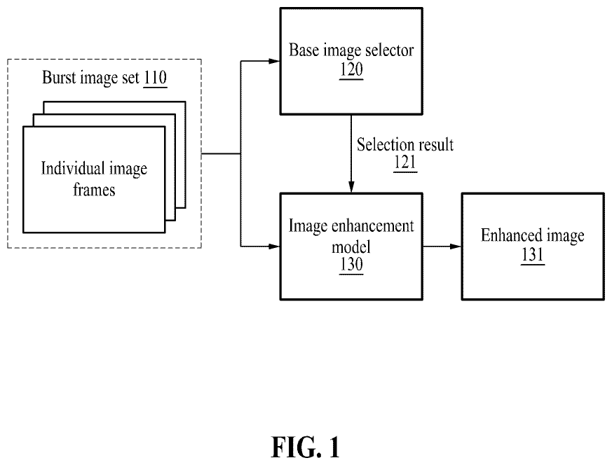

FIG. 1 illustrates an example of generating an enhanced image from a burst image set, according to one or more embodiments. Referring to FIG. 1, a burst image set 110 may be generated by continuous shooting with a camera. The burst image set 110 may include individual image frames. The burst image set 110 may be generated in an environment in which image degradation may occur, such as a low-light environment or an environment in which camera shake exists (e.g., hand-held shooting). The individual image frames of the burst image set 110 may be a composite degraded image including various degradation components such as noise and blur. The burst image set 110 may be taken automatically a high frequency, e.g., 10 or 20 images per second. In addition, although examples are described herein with reference to burst images, the examples and techniques may be applied to any sequence of images regardless of how the images are captured, for example, frames of a high-speed video camera. Thus, the phrase “burst image set” may also be referred to as an “image set”, an “image sequence”, or the like.

An enhanced image 131 corresponding to the burst image set 110 may be generated using a base image selector 120 and an image enhancement model 130. The enhanced image 131 generated using the burst image set 110 may exhibit higher quality than a single degraded image such as each individual image frame of the burst image set 110. A high-quality image may be generated using the burst image set 110 in an environment in which image degradation usually occurs (e.g., low light, a moving camera of subject, etc.).

The base image selector 120 may select a base image frame from among the individual image frames of the burst image set 110. The image enhancement model 130 may perform an image enhancement task using one of the individual image frames as the base image frame. The effect of image enhancement may vary depending on which of the individual image frames is used as the base image frame. The base image selector 120 may select, as the base image frame, one of the individual image frames that is determined to be expected to have the greatest image enhancement effect. A selection result 121 may include identification information of the base image frame or the base image frame itself. The image enhancement model 130 may perform an image enhancement task based on the selection result 121 to generate the enhanced image 131. Image enhancement may be a task of improving quality of an input image by removing various deterioration components such as noise and blur, for example. The base image selector may be trained to perform an optimal selection. Individual image frames of a burst image set may be in a degraded state. The base image selected from the individual image frames may be in a degraded state. The base image may be enhanced based on image information of other individual image frames of the burst image set. The type of enhancement may depend on configurations and structures of the image enhancement model, and the type of enhancement is not limited in the present invention. The enhanced image may correspond to an improved base image, but it is merely one image generated by the image enhancement model based on the burst image set. In sum, the image enhancement model may use a selection result of the basic image selector. However, other information of the base image selector may be used by the image enhancement model.

The base image selector 120 may include/be a neural network. The base image selector 120 may be trained to select the base image frame from individual image frames of the burst image set 110. The neural network may be/include a deep neural network (DNN) including multiple layers. The DNN may include at least one of a fully connected network (FCN), a convolutional neural network (CNN), or a recurrent neural network (RNN). For example, at least some of the layers included in the neural network may correspond to the CNN, and some others may correspond to the FCN. The CNN may be referred to as convolutional layers, and the FCN may be referred to as fully connected layers. The term “CNN” may also refer to a model that includes both convolutional layers as well as FCN layers.

The neural network may be trained based on deep learning and perform inference suitable for a training purpose by mapping input data and output data that are in a nonlinear relationship to each other. Deep learning is a machine learning technique for solving a problem such as image or speech recognition from a big data set. Deep learning may be construed as an optimization problem-solving process of finding a point at which energy is minimized while training a neural network using prepared training data. Through supervised or unsupervised learning of deep learning, a structure of the neural network or a weight of a model may be obtained, and the input data and the output data may be mapped to each other through the weight. When a width and a depth of the neural network are sufficiently great, the neural network may have a capacity sufficient to implement a predetermined function. When the neural network is trained on a sufficiently large quantity of training data through an appropriate training process, optimal performance may be achieved.

To elaborate, the image base image selector 120 and/or the image enhancement model 130 may be implemented as a neural network having layers of nodes. The layers may include an input layer, one or more hidden layers, and an output layer. Each layer may include nodes with connections to nodes in an adjacent layer (or possibly a non-adjacent layer). The connections may have respective weights (nodes may each have their own parameters such as a bias). The neural network model may be a feed forward model. Parameters such as weights and biases may be set for the neural network model by supervised training. Supervised training may involve inputting a training input (e.g., a training image) to the model. A loss may be found between a ground truth (GT) of the training input and an inference of the model. The inference based on the training input and parameters (e.g., weights) of the model. The parameters of the model may be updated in a way that reduces the loss, for example, by using backpropagation, gradient descent, etc.

The base image selector 120 may use spatial feature representations of respective individual image frames in selecting the base image frame. The spatial feature representations may be composite degradation maps. The spatial feature representation of a given image frame may represent, for each pixel of the given frame, a level of composite degradation present in the given image frame. The base image selector 120 may identify a composite degradation level of each of the individual image frames using the spatial feature representations and may refer to the composite degradation levels in selecting the base image frame (“composite degradation” refer to a combination of degradation types, noise and blur, which may result from moving a camera and/or object).

The base image selector 120 may use temporal feature representations of the respective individual image frames in selecting the base image frame. Motion may occur in a situation such as hand-held shooting. Such motion may result in blur and other artifacts. The base image selector 120 may generate discriminative temporal feature representations based on local similarities of the respective individual image frames and may predict the composite degradation levels of the respective individual image frames based on the discriminative temporal feature representations. For example, the base image selector 120 may use feature representations generated based on a local spatial-temporal self-similarity. The local spatial-temporal self-similarity may include motion information of the individual image frames and may be used to help select an individual image frame that does not significantly deviate from a motion trajectory as the base image frame.

The image enhancement model 130 may be/include a neural network. The image enhancement model 130 may be trained to able to generate the enhanced image 131 based on the individual image frames of the burst image set 110. The image enhancement model 130 may generate the enhanced image 131 by performing an image enhancement task on the individual image frames of the burst image set 110 based on the base image frame (e.g., the selection result 121). The base image selector 120 may be coupled to the image enhancement model 130 in a plug-and-play manner. In this case, the base image selector 120 may be used to enhance the image enhancement performance of the existing image enhancement model 130.

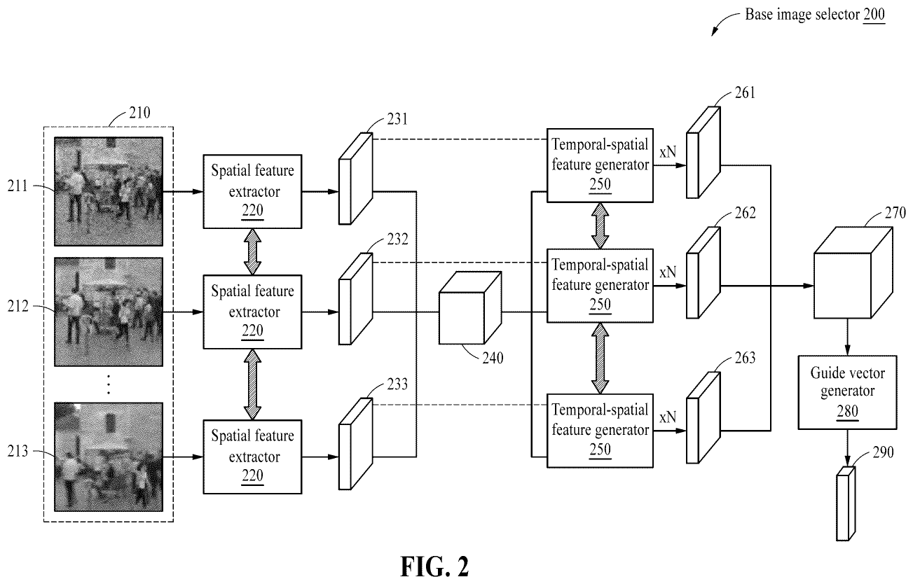

FIG. 2 illustrates an example of a base image selector, according to one or more embodiments. Referring to FIG. 2, a base image selector 200 may include spatial feature extractors 220, temporal-spatial feature generators 250, and a guide vector generator 280. The spatial feature extractors 220, the temporal-spatial feature generators 250, and the guide vector generator 280 may each be implemented based on (as) a neural network, according to one or more embodiments.

A burst image set 210 may include individual image frames 211 to 213. The individual image frames 211 to 213 may be generated with different exposure times (e.g., progressive exposure). The exposure times may be determined in advance, and a camera may generate the individual image frames 211 to 213 based on the predetermined exposure times. In other implementations, the individual image frames are captured with a different varying parameter or without variation of a parameter. The individual image frames 211 to 213 may have composite degradation. For example, a first individual image frame 211 of the individual image frames 211 to 213 that is captured with a relatively short exposure may have a relatively high noise level and a relatively low blur level, and a second individual image frame 212 of the individual image frames 211 to 213 that is captured with a longer exposure may have a low noise level and a high blur level relative to the first individual image frame 211.

The spatial feature extractor 220 may extract spatial feature representations 231 to 233 (e.g., feature maps representing spatial features) from the individual image frames 211 to 213, respectively. A spatial feature may also be referred to as an intra-frame feature, that is, a feature that is contained within the corresponding frame image. Each spatial feature extractor 220 may be/include a neural network capable of feature extraction, such as a CNN or a transformer. The spatial feature extractor 220 may extract features of the individual image frames 211 to 213 either sequentially or in parallel. In the sequential case, there may be only one spatial feature extractor 220, whereas in the parallel case there may be multiple spatial feature extractors which may share parameters such as weights.

The spatial feature representations 231 to 233 may be merged into a spatial feature representation set 240 (e.g., a volume of spatial feature maps). For example, concatenation may be used to merge the spatial feature representations 231 to 233 into the spatial feature representation set 240. The spatial feature representations 231 to 233 may each have a size of H×W×C, and the spatial feature representation set 240 may have a size of H×W×K×C, where H is a height, W is a width, and C is a channel dimension. K is the number of the individual image frames 211 to 213 of the burst image set 210. Data of the spatial feature representations 231 to 233 may be maintained in the spatial feature representation set 240. Therefore, the spatial feature representation set 240 may also be referred to as the spatial feature representations 231 to 233.

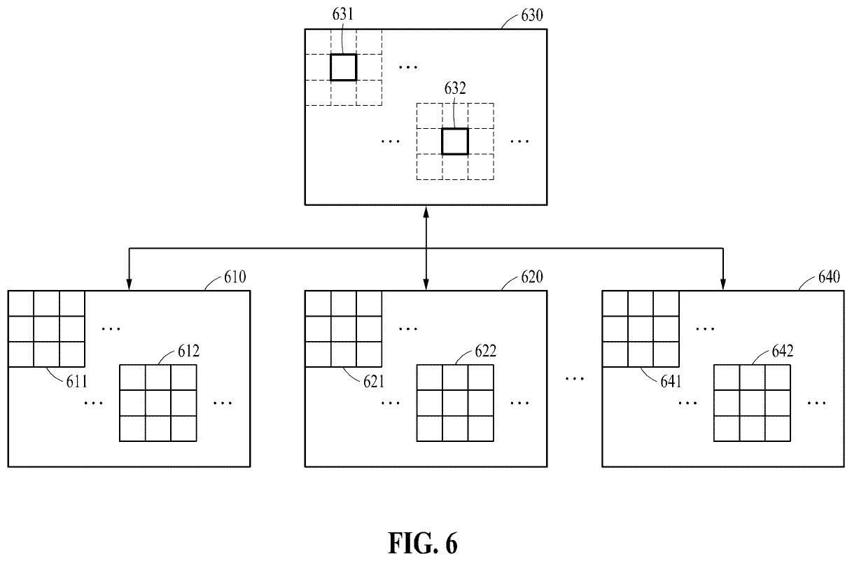

The temporal-spatial feature generators 250 may generate respective temporal-spatial feature representations 261 to 263 (e.g., feature maps) respectively corresponding to the spatial feature representations 231 to 233 (and corresponding frames) and to the spatial feature expression set 240. In a non-limiting example, each temporal-spatial feature generator may receive the spatial feature representation set 240 of the burst image set 210, in addition, either by configuration or by a signal, each temporal-spatial feature generator knows which frame image it corresponds to. For example, for the first frame image in the burst image set 210, the first temporal-spatial feature generator 250 may receive the spatial feature representation set 240 and may perform temporal-spatial feature analysis of the first frame (vis a vis the first spatial feature representation 231 in the spatial feature representation set 240) against the other frames (which are included in the spatial feature representation set 240). The temporal-spatial feature generators 250 may generate the respective temporal feature representations (mentioned above with reference to FIG. 1) based on local similarities between the spatial feature expressions 231 to 233 and may generate the temporal-spatial feature representations 261 to 263 by fusing the spatial feature representations 231 to 233 and the temporal feature representations. Examples of local similarities are described with reference to FIG. 6. The temporal-spatial feature generator 250 may generate the temporal-spatial feature representations 261 to 263 either sequentially or in parallel. As with the spatial feature extractors, in the latter case of a sequential/serial implementation, one temporal-feature generator may generate the temporal-spatial feature representations in turn, or, in a parallel implementation, multiple temporal-spatial feature generators may operate at the same time, and may share/have same parameters (e.g., weights).

The temporal-spatial feature representations 261 to 263 may be merged into a temporal-spatial feature representation set 270. For example, concatenation may be used to merge the temporal-spatial feature representations 261 to 263 into the temporal-spatial feature representation set 270. The temporal-spatial feature representations 261 to 263 may each have a size of H″×W″×1, and the temporal-spatial feature representation set 270 may have a size of H″×W″×K×1. Data of the temporal-spatial feature representations 261 to 263 may be maintained in the temporal-spatial feature representation set 270. Therefore, the temporal-spatial feature representation set 270 may also be referred to as the temporal-spatial feature representations 261 to 263.

The guide vector generator 280 may generate a selection guide vector 290 corresponding to (and based on) the temporal-spatial feature representation set 270. The selection guide vector 290 may have a size of K×1 (again, K being the number of frame images). Vector values of the selection guide vector 290 may indicate the suitability of each of the individual image frames 211 to 213 as a base image frame. The base image frame may be selected from the individual image frames 211 to 213 based on the vector values of the selection guide vector 290 (e.g., the frame image whose corresponding vector element has the highest value). During a training process, the inference process of the base image selector 200 may be as described above, and the training may be according to a loss between the selection guide vector 290 inferred by the guide vector generator 280 from a training burst image set and ground truth (GT) associated therewith (e.g., a GT guide vector or a GT indication of the correct base image in the training burst image set).

The temporal-spatial feature generators 250 may iterate, N times, the generation of the temporal feature representations and the determination of the temporal-spatial feature representations 261 to 263. The temporal-spatial feature representations 261 to 263 generated through N iteration times may be referred to as final temporal-spatial feature representations. The base image frame may be selected based on the final temporal-spatial feature representations obtained as a result of the iterations. The example of using three frame images in a burst image set, three spatial feature expressions, and three temporal-spatial feature representations is a non-limiting example; two or more than three may be used.

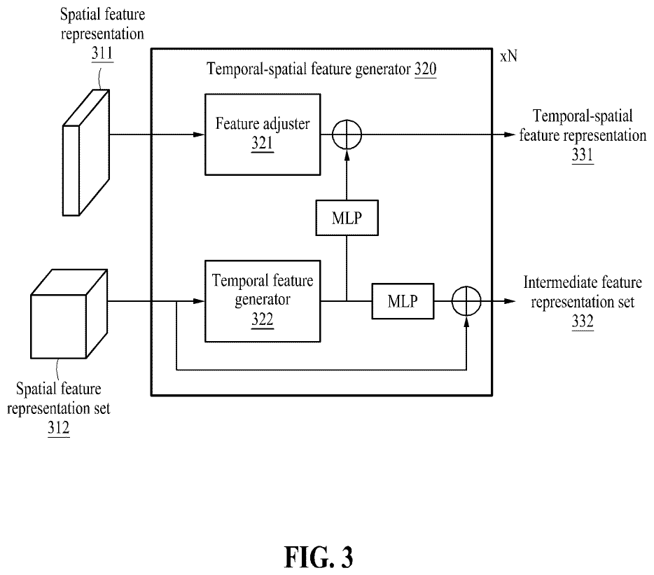

FIG. 3 illustrates an example of a temporal-spatial feature generator, according to one or more embodiments. Referring to FIG. 3, a temporal-spatial feature generator 320 (e.g., a temporal-spatial feature generator 250) may include a feature adjuster 321, a temporal feature generator 322, and a multi-layer perceptron (MLP). In some cases, an MLP may be replaced by another network or algorithm or may be omitted.

The temporal feature generator 322 may generate temporal feature representations from a spatial feature representation set 312 based on a local similarity between spatial feature representations. For example, the temporal feature generator 322 may select a target spatial feature representation from among the spatial feature representations in the spatial feature representation set 312, compare window regions of the target spatial feature representation with corresponding search regions of the spatial feature representations, and generate a temporal feature representation corresponding to the target spatial feature representation based on a result of the comparison. The temporal feature generator 322 may perform the comparison operations described above while sequentially designating each of the spatial feature representations of the spatial feature representation set 312 as the target spatial feature representation. When the comparison operations for all of the spatial feature representations are completed, temporal feature representations respectively corresponding to the spatial feature representations (and the frame images) of the spatial feature representation set 312 may be generated. The size of the temporal feature representations may be H×W×K×C.

Intuitively, finding local similarities between a first region corresponding to one frame image and related regions (e.g., near/overlapping) of another frame image reveals temporal comparative information. More specifically, the local similarity may be determined using a window region and a search region. The size of the search region may be greater than the size of the window region. For example, a search region of a determined size (e.g., a 3×3 region, a 5×5 region, etc.) may be determined such that a corresponding region of a spatial feature representation corresponding to a window region (e.g., a 1×1 region) of the target spatial feature representation may be included in the center of the search region. According to window sliding, window regions may be formed in the target spatial feature representation and a search region corresponding to each window region may be determined in the spatial feature representation. For example, in order to compare the window regions of the target spatial feature representation with the search regions of the other spatial feature representations, the temporal feature generator 322 may select a first spatial feature representation (from among the spatial feature representations). The temporal feature generator 322 may then (A) compare (i) a first window region (of the window regions) of the target spatial feature representation with (ii) a first search region (corresponding to the first window region) but in the first spatial feature representation, and (B) compare (i) a second window region (of the window regions) of the target spatial feature representation with (ii) a second search region (corresponding to the second window region) but in the first spatial feature representation. Such comparisons may be and for different regions and for different spatial feature representations, as needed. As noted earlier, the temporal feature representations generated based on the local similarity between the spatial feature representations as described above may include motion information as between the individual video frames.

The temporal feature representations generated by the temporal feature generator 322 may be fused with a spatial feature representation 311. Before fusion, the spatial feature representation 311 may be adjusted by the feature adjuster 321. For example, the feature adjuster 321 may be a 3×3 convolutional layer. The temporal feature representations may be adjusted by an MLP to have the same size as the spatial feature representation 311. For example, the temporal feature representations of a size of H×W×K×C may be adjusted by an MLP to have a size of H×W×K. Subsequently, the temporal feature representations may be fused with the spatial feature representation 311 adjusted by the feature adjuster 321. For example, the spatial feature representation 311 and the temporal feature representations may be fused together based on an elementwise addition operation of feature values of the spatial feature representation 311 and feature values of the temporal feature representations. A fusion result may serve as a temporal-spatial feature representation 331.

When needed, the temporal feature representations may be adjusted by the MLP to have the same size as the spatial feature representation set 312. When the spatial feature representation set 312 and the temporal feature representations already have the same size, the MLP may be omitted. The spatial feature representation set 312 and the temporal feature representations may be fused based on an elementwise addition operation. An intermediate feature representation set 332 may correspond to the fusion result.

The temporal-spatial feature generator 320 may iterate a temporal-spatial feature generation operation using the temporal-spatial feature representation 331 and the intermediate feature representation set 332 instead of the spatial feature representation 311 and the spatial feature representation set 312. The temporal-spatial feature generation operation may be iterated N times. The temporal-spatial feature representation 331 generated by an N-th iteration may be used as a final temporal-spatial feature representation. The intermediate feature representation set 332 generated by the N-th iteration may be discarded. Iterative operation is described next.

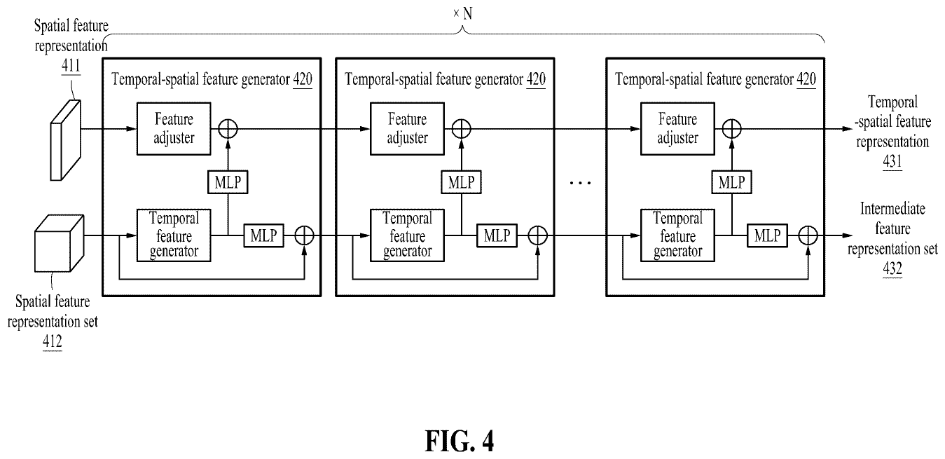

FIG. 4 illustrates an example of an iterative operation of a temporal-spatial feature generator, according to one or more embodiments. Referring to FIG. 4, a temporal-spatial feature generator 420 may iterate a temporal-spatial feature generation operation N times. Although FIG. 4 shows multiple instances of the temporal-spatial feature generator 420; each instance may be a different iteration of the same generator. That is, an intermediate result may be fed back to the same generator for a next iteration. In the first iteration, the temporal-spatial feature generator 420 may perform a temporal-spatial feature generation operation using a spatial feature representation 411 and a spatial feature representation set 412. In a second to an N-th iterations, the temporal-spatial feature generator 420 may perform a temporal-spatial feature generation operation using a temporal-spatial feature representation 431 and an intermediate feature representation set 432 generated by a previous iteration. The temporal-spatial feature representation 431 generated in the N-th iteration may be used as a final temporal-spatial feature representation, and the intermediate feature representation set 432 generated in the N-th iteration may be discarded.

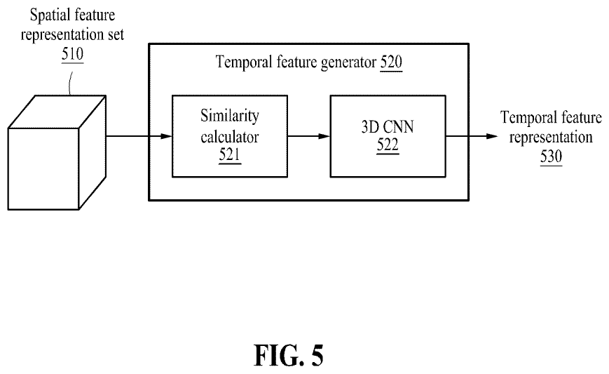

FIG. 5 illustrates an example of a temporal feature generator, according to one or more embodiments. Referring to FIG. 5, a temporal feature generator 520 may include a similarity calculator 521 and a three-dimensional (3D) CNN 522. The similarity calculator 521 may calculate a local similarity between spatial feature representations of a spatial feature representation set 510. The similarity calculator 521 may compare window regions of a target spatial feature representation with search regions of the spatial feature representations and may generate an intermediate temporal feature representation corresponding to the target spatial feature representation based on a result of the comparison. The 3D CNN 522 may generate a temporal feature representation 530 corresponding to the intermediate temporal feature representation using a 3D weight kernel.

FIG. 6 illustrates an example similarity calculation process using window regions and search regions, according to one or more embodiments. FIG. 6 may be an example in which a third spatial feature representation 630 is selected, from among spatial feature representations 610 to 640, as a target spatial feature representation, and a local similarity between the third spatial feature representation 630 and the spatial feature representations 610 to 640 is calculated (excluding comparison between the first spatial feature representation 630 and itself). The local similarity may be a local self-similarity. The local similarity may include a calculation result between the third spatial feature representation 630 and the other spatial feature representations 610, 620, and 640, and a self-calculation result for the third spatial feature representation 630 itself.

When a first window region 631 is selected in the third spatial feature representation 630 (the target spatial feature representation), first search regions 611, 621, and 641 corresponding to the first window region 631 may be determined in the spatial feature representations 610, 620, and 640, respectively. Search regions including the first search regions 611, 621, and 641 may be larger than window regions including the first window region 631. For example, the window regions (of the target spatial feature representation) may each be a 1×1 region, and the search regions may each be a 3×3 region or a 5×5 region. However, examples are not limited thereto. The first window region 631 may be compared with each of sub-regions (e.g., 3×3 sub-regions of FIG. 6) of the first search regions 611, 621, and 641. For example, a cosine distance may be used to calculate a similarity. However, examples are not limited thereto. A result of the comparison may be stored as similarity data regarding the first window region 631. Similarly, a second window region 632 may be compared with second search regions 612, 622, and 642. Generally a higher similarity measure for a 1×1 region will indicate a lower degree of motion. Incidentally, the region sizes are non-limiting examples.

When local similarity calculations for all window regions of the third spatial feature representation 630 is completed, an intermediate temporal feature representation having a size of H×W×K×C may be generated. Accordingly, a temporal feature representation corresponding to each individual image frame may be generated. For example, referring to FIG. 2, the temporal-spatial feature generator 250 may select, from among the spatial feature representations 231 to 233 respectively corresponding to the individual image frames 211 to 213, a first spatial feature representation corresponding to the first individual image frame 211 as the target spatial feature representation, generate a first temporal feature representation corresponding to the first spatial feature representation, and generate the first temporal-spatial feature representation 261 based on the first temporal feature representation. In addition, the temporal-spatial feature generator 250 may select a second spatial feature representation corresponding to the second individual image frame 212 as the target spatial feature representation, generate a second temporal feature representation corresponding to the second spatial feature representation, and generate a second temporal-spatial feature representation 262 based on the second temporal feature representation.

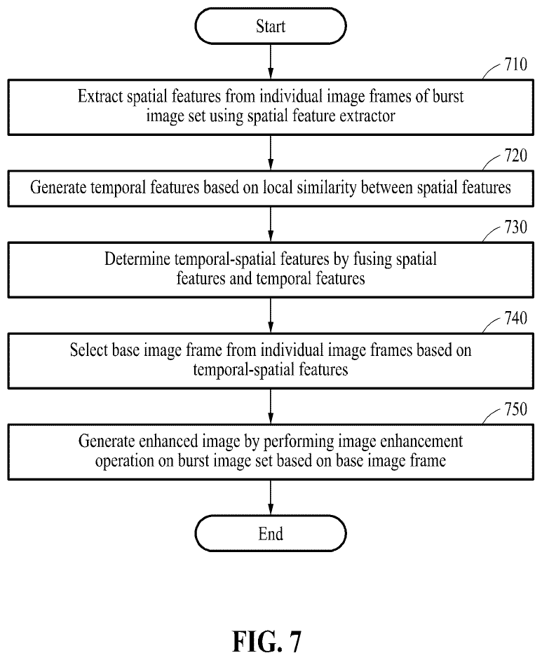

FIG. 7 illustrates an example of an image enhancement method, according to one or more embodiments. Referring to FIG. 7, an electronic device may extract spatial feature representations from respective individual image frames of a burst image set using a spatial feature extractor in operation 710, generate temporal feature representations based on local similarities between the spatial feature representations in operation 720, determine temporal-spatial feature representations by fusing the spatial feature representations and the temporal feature representations in operation 730, select a base image frame from among the individual image frames based on the temporal-spatial feature representations in operation 740, and generate an enhanced image by performing an image enhancement operation on the burst image set based on the base image frame in operation 750.

Operation 720 may include selecting a target spatial feature representation from among the spatial feature representations, comparing window regions of the target spatial feature representation with spatially-corresponding search regions of the spatial feature representations, and generating a temporal feature representation corresponding to the target spatial feature representation based on a result of the comparison, the temporal feature representation being included in the temporal feature representations.

An operation of comparing window regions of the target spatial feature representation with search regions of the spatial feature representations may include selecting a first spatial feature representation from the spatial feature representations, comparing a first window region of the window regions of the target spatial feature representation with a first search region corresponding to the first window region in the first spatial feature representation, and comparing a second window region of the window regions of the target spatial feature representation with a second search region corresponding to the second window region in the first spatial feature representation.

The temporal feature representations may include information of motion between the individual image frames.

Operation 730 may include matching a size of the spatial feature representations with a size of the temporal feature representations and determining the temporal-spatial feature representations based on an elementwise addition operation of feature values of the spatial feature representations and feature values of the temporal feature representations.

An operation of generating the temporal feature representations and an operation of determining the temporal-spatial feature representations may be iteratively performed, and a base image frame may be selected based on final temporal-spatial feature representations obtained as a result of the iterations.

The individual image frames may have composite degradation (i.e., spatial and temporal degradation). For example, the individual image frames may be generated with different/graduated exposure times.

Operation 740 may include (i) generating a selection guide vector corresponding to the temporal-spatial feature representations and (ii) selecting the base image frame from the individual image frames based on vector values of the selection guide vector. The values of the vectors may represent levels of spatial-temporal degradation of the respective frame images, for example.

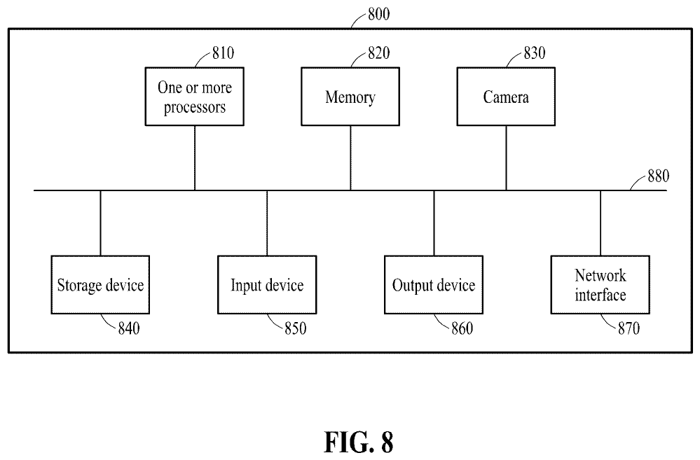

FIG. 8 illustrates an example of an electronic device, according to one or more embodiments. Referring to FIG. 8, an electronic device 800 may include one or more processors 810, a memory 820, a camera 830, a storage device 840, an input device 850, an output device 860, and a network interface 870, and these components may communicate with each other through a communication bus 880. For example, the electronic device 800 may be implemented as at least a portion of, for example, a mobile device such as a mobile phone, a smartphone, a personal digital assistant (PDA), a netbook, a tablet computer, a laptop computer, and the like, a wearable device such as a smart watch, a smart band, smart glasses, and the like, a home appliance such as a television (TV), a smart TV, a refrigerator, and the like, a security device such as a door lock and the like, and a vehicle such as an autonomous vehicle, a smart vehicle, and the like.

The one or more processors 810 may execute instructions and functions in the electronic device 800. For example, the one or more processors 810 may process instructions stored in the memory 820 or the storage device 840. The one or more processors 810 may perform the operations described with reference to FIGS. 1 to 7. The memory 820 may include a non-transitory computer-readable storage medium or a non-transitory computer-readable storage device. The memory 820 may store instructions that are to be executed by the one or more processors 810 and may also store information associated with software and/or applications when the software and/or applications are being executed by the electronic device 800. The one or more processors 810 may be any of the types of processors mentioned below (or others), or a combination of an of the types of processors.

The camera 830 may capture a photo and/or a video. For example, the camera 830 may capture a burst image set. In this case, the camera 830 may generate individual image frames of the burst image set with different exposure times. The exposure times may be set in advance.

The storage device 840 may include a non-transitory computer-readable storage medium or a non-transitory computer-readable storage device (but not a signal per se). The storage device 840 may store a greater amount of information than the memory 820 for a longer period of time. For example, the storage device 840 may include a magnetic hard disk, optical disc, flash memory, floppy disk, or other types of non-volatile memory known in the art.

The input device 850 may receive an input from a user in traditional input manners through a keyboard and a mouse and in new input manners such as a touch input, a voice input, and an image input. For example, the input device 850 may include a keyboard, a mouse, a touch screen, a microphone, or any other device that detects the input from the user and transmits the detected input to the electronic device 800. The output device 860 may provide an output of the electronic device 800 to the user through a visual, auditory, or haptic channel. The output device 860 may include, for example, a display, a touch screen, a speaker, a vibration generator, or any other device that provides the output to the user. The network interface 870 may communicate with an external device through a wired or wireless network.

The computing apparatuses, the electronic devices, the processors, the memories, the image sensors, the displays, the information output system and hardware, the storage devices, and other apparatuses, devices, units, modules, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An image enhancement method comprising:
extracting, by a spatial feature extractor, intra-image spatial feature representations from respective image frames of a burst image set;
generating inter-image temporal feature representations based on a local similarity between the spatial feature representations;
determining temporal-spatial feature representations of the respective image frames by fusing the spatial feature representations with the temporal feature representations;
selecting a base image frame from among the image frames based on the temporal-spatial feature representations; and
generating an enhanced image by performing an image enhancement operation on the burst image set based on the base image frame.

2. The image enhancement method of claim 1, wherein the generating of the temporal feature representations comprises:
selecting a target spatial feature representation from among the spatial feature representations;
comparing window regions of the target spatial feature representation with spatially-corresponding search regions of the spatial feature representations; and
generating a temporal feature representation corresponding to the target spatial feature representation based on a result of the comparison, the temporal feature representation being included in the temporal feature representations.

3. The image enhancement method of claim 2, wherein the comparing of the window regions of the target spatial feature representation with the spatially-corresponding search regions of the spatial feature representations comprises:
selecting a first spatial feature representation from among the spatial feature representations;
comparing a first window region of the window regions of the target spatial feature representation with a first search region spatially-corresponding to the first window region in the first spatial feature representation; and
comparing a second window region of the window regions of the target spatial feature representation with a second search region spatially-corresponding to the second window region in the first spatial feature representation.

4. The image enhancement method of claim 1, wherein the temporal feature representations comprise:
motion information of the respective image frames.

5. The image enhancement method of claim 1, wherein the determining of the temporal-spatial feature representations comprises:
causing a size of the spatial feature representations to equal a size of the temporal feature representations; and
determining the temporal-spatial feature representations based on an elementwise addition operation of feature values of the spatial feature representations and feature values of the temporal feature representations.

6. The image enhancement method of claim 1, wherein
the generating of the temporal feature representations and the determining of the temporal-spatial feature representations are iteratively performed, and
the base image frame is selected based on final temporal-spatial feature representations obtained as a result of the iterations.

7. The image enhancement method of claim 1, wherein the individual image frames have composite degradation.

8. The image enhancement method of claim 1, wherein the individual image frames are captured with different respective exposure times.

9. The image enhancement method of claim 1, wherein the selecting of the base image frame comprises:
generating a selection guide vector corresponding to the temporal-spatial feature representations, wherein elements of the selection guide vector respectively correspond to the frame images; and
selecting the base image frame from among the individual image frames based on values of the elements of the selection guide vector.

10. The method of claim 1, wherein the temporal feature representations are feature maps generated by a first neural network, wherein the spatial-temporal features are feature maps generated by second neural network, and wherein a spatial-temporal feature map comprises spatial-temporal features of a corresponding image frame relative to other of the image frames.

11. An electronic device comprising:
one or more processors; and
a memory storing instructions configured to cause the one or more processors to:
extract, by a spatial feature extractor, intra-image spatial feature representations from respective image frames of a burst image set;
generate inter-image temporal feature representations based on a local similarity between the spatial feature representations;
determine temporal-spatial feature representations of the respective image frames by fusing the spatial feature representations with the temporal feature representations;
select a base image frame from among the individual image frames based on the temporal-spatial feature representations; and
generate an enhanced image by performing an image enhancement operation on the burst image set based on the base image frame.

12. The electronic device of claim 11, wherein, in order to generate the temporal feature representations, the instructions are further configured to cause the one or more processors to:
select a target spatial feature representation from among the spatial feature representations;
compare window regions of the target spatial feature representation with spatially-corresponding search regions of the spatial feature representations; and
generate a temporal feature representation corresponding to the target spatial feature representation based on a result of the comparison, the temporal feature representation being included in the temporal feature representations.

13. The electronic device of claim 12, wherein, in order to compare the window regions of the target spatial feature representation with the search regions of the spatial feature representations, the instructions are further configured to cause the one or more processors to:
select a first spatial feature representation from among the spatial feature representations;
compare a first window region of the window regions of the target spatial feature representation with a first search region spatially-corresponding to the first window region in the first spatial feature representation; and
compare a second window region of the window regions of the target spatial feature representation with a second search region spatially-corresponding to the second window region in the first spatial feature representation.

14. The electronic device of claim 11, wherein the temporal feature representations comprise:
motion information of the respective image frames.

15. The electronic device of claim 11, wherein, in order to determine the temporal-spatial feature representations, the instructions may be further configured to cause the one or more processors to:
cause a size of the spatial feature representations to equal a size of the temporal feature representations; and
determine the temporal-spatial feature representations based on an elementwise addition operation of feature values of the spatial feature representations and feature values of the temporal feature representations.

16. The electronic device of claim 11, wherein
the generating of the temporal feature representations and the determining of the temporal-spatial feature representations are iteratively performed, and
the base image frame is selected based on final temporal-spatial feature representations obtained as a result of the iterations.

17. The electronic device of claim 11, wherein the individual image frames have composite degradation.

18. The electronic device of claim 11, wherein the electronic device further comprises:
a camera configured to capture the burst image set.

19. The electronic device of claim 18, wherein the camera is configured to:
capture the individual image frames of the burst image set with different respective exposure times.

20. The electronic device of claim 11, wherein, in order to select the base image frame, the instructions are further configured to cause the one or more processors to:
generate a selection guide vector corresponding to the temporal-spatial feature representations, wherein elements of the selection guide vector respectively correspond to the frame images; and
select the base image frame from among the individual image frames based on values of the elements of the selection guide vector.
